(19) United States
(12) Patent Application Publication
(10) Pub. No.: US 2021/0155195 A1
(43) Pub. Date: May 27, 2021

(54) REARWARD-FACING SEAT WITH SAFETY REINFORCEMENT

(71) Applicant: Volvo Car Corporation, Goteborg (SE)

(72) Inventors: Erik Sandborg, Goteborg (SE); Magnus Bjorklund, Torslanda (SE); Richard Nilsson, Goteborg (SE)

(21) Appl. No.: 17/097,412

(22) Filed: Nov. 13, 2020

(30) Foreign Application Priority Data
Nov. 21, 2019 (EP) 19210756.3

(51) Int. Cl. B60R 21/207; B60N 2/005; B60N 2/42; B60R 21/239; B60R 21/26; B60R 21/015

(52) U.S. Cl. CPC B60R 21/207; B60N 2/005; B60N 2/42; B60R 21/01512; B60R 21/26; B60R 21/01558; B60R 21/239

(57) ABSTRACT

A rearward-facing seat with safety reinforcement includes a base; a back; and an adaptive damping device behind an upper portion of the back of the seat. The adaptive damping device can be an inflatable airbag, crushable material or spring. The damping device can adapt to one or more of crash severity, crash conditions, occupant position or occupant size.

### CROSS REFERENCE TO RELATED APPLICATION

This application claims priority to European Patent Application Serial No. 19210756.3 filed Nov. 21, 2019 and entitled “REARWARD-FACING SEAT WITH SAFETY REINFORCEMENT,” the entirety of which is herein incorporated by reference.

### TECHNICAL FIELD

The invention relates to a safety configuration for vehicles with rearward-facing seats.

The invention also relates to a vehicle with a rearward-facing seat with a safety device; and a method of safety-reinforcement for a rearward-facing seat.

### BACKGROUND

New car designs involve rearward-facing seating configurations. Such configurations result in new forces for the car and occupants, particularly in relation to an accident with sudden large forces. Some past car designs included seats which could pivot to face forward or rearward, and had some safety devices associated with protecting a passenger in a turnable seat. These were typically either a cushion positioned at the back of the turnable seat or an inflatable device connected to the seat that extends to the sides and possibly above the person to restrain the passenger in the reversible seat in the event of a collision.

### SUMMARY

It is an object of one or more embodiments of the invention to provide a safety configuration for rearward-facing seats in vehicles. Past systems with rearward-facing seats were related to reversible seating. Due to that, any safety configurations were typically limited and had to be connected to the seat itself for use in forward facing positions or rearward-facing configuration. Additionally, rearward-facing seat configurations result in high forces for occupants in frontal impact collision, forces which are significantly higher than rearward impacts. Past safety solutions for rear impact collisions are not sufficient for frontal impact forces, and are not adaptive to different passengers and/or crash conditions. Thus, there is a need for safety solutions for rearward-facing seat configurations in a frontal impact situation, and particularly for safety solutions which can adapt to the passenger and/or crash conditions

According to a first aspect of the invention, a rearward-facing seat includes a base, a back and an adaptive damping device behind an upper portion of the back of the seat. Such a configuration ensures that the rearward-facing seat occupant is protected by the adaptive damping device. The placement behind an upper portion of the back of the seat helps to cushion the torso, neck and head from strong forces in a collision, which can be especially useful for protection of an occupant of a rearward-facing seat in a frontal collision. Frontal collisions subject the vehicle and thus the occupants to large forces due to the sudden deceleration, and thus the rearward-facing seat with adaptive damping device can protect an occupant in such a situation.

According to an embodiment, the adaptive damping device is an inflatable airbag. Optionally, the inflatable airbag comprises ventilation holes. An inflatable airbag can be supplied with gas through a connected adaptive gas generator. The inflatable airbag can be inflated to different levels to adapt to different occupant and/or collision conditions. This can be through the supply of gas to the airbag and/or through the ventilation holes.

According to an embodiment, the adaptive damping device is connected to an upper portion of the back of the seat behind the seat. A further option is to have the adaptive damping device to be located within the seat, at least in an undeployed condition. Connecting to the seat itself or locating within the seat can ensure that the airbag is properly positioned for providing damping for the occupant no matter the collision or damage to the vehicle resulting from the collision. Additionally, connection directly to the seat can ensure a compact package that could be manufactured at a different location and simply inserted into a vehicle, even allowing for the adapting of vehicles which previously only had forward facing seats to now include rearward-facing seats with adaptable safety devices. In embodiments where the airbag is connected to or within the seat, a gas generator can also be connected to or within the seat.

According to an embodiment, the adaptive damping device is connected to a vehicle structure. This could be any part of the vehicle structure or frame, for example an cross car beam, upper dash and/or cowl. Such a configuration would give the adaptive damping device a configuration to secure to the vehicle and provide damping forces for occupant safety.

According to an embodiment, the seat further comprises a head rest connected to the back. Optionally, the adaptive damping device extends at least partially behind the head rest. This can be to the top of the head rest or at least partially up the headrest toward the top. Such a configuration can help to protect an occupant of seat from injuries to the head, torso, neck and brain in the event of a collision. Optionally, the seatback and/or headrest geometry can be designed for airbag interaction, shaped such that the airbag can achieve the best possible performance for damping and reinforcing the seatback (and headrest) in the event of a collision.

According to an embodiment, the adaptive damping device adapts based on one or more of crash severity, crash conditions, occupant position and/or occupant size. This can be related to one or more of the direction of the crash, e.g., frontal, rear or side crash; to the severity of the crash, e.g., sudden accelerations or decelerations; the position of the occupant in the seat; and/or the occupant's height and/or weight. Such information can be provided to the adaptive damping device by one or more sensors located in the seat or elsewhere in the vehicle. Such sensors can be one or more of crash or impact sensors, acceleration/deceleration sensors, safety sensors to measure the severity of an impact, occupant weight or height sensors; and/or occupant position sensors (e.g., a camera or sensor on the safety belt to know whether applicant is sitting back in the seat), etc. Such sensors can send information or signals to the adaptive damping device which will cause the device to appropriate adjust the damping level according to the information sent.

According to an embodiment, the adaptive damping device comprises an adaptive gas generator to regulate the mass flow to the damping device. This allows for achieving the right pressure in airbag according to information or signals related to crash severity, crash conditions, occupant position and/or occupant size.

According to a further aspect of the invention, a vehicle includes a rearward-facing seat with the adaptive damping device. Such a configuration of a vehicle can ensure that an occupant in the rearward-facing seat is protected in the event of a collision, even in the face of strong forces, for example, from a frontal collision.

According to a further aspect of the invention, a method of safety reinforcement for a rearward-facing seat comprises positioning an adaptive damping device behind an upper portion of a back of the rearward-facing seat. The adaptive damping device could be connected to the seat and/or the vehicle. Such a method provides rearward-facing seat with an adaptive system to ensure safety of an occupant in the case of a collision.

According to an embodiment, the method further comprises providing one or more sensors to provide signals or information for the adaptive damping device to adapt according to one or more of crash severity, crash conditions, occupant position and/or occupant size. Such an adaptive safety system is able to provide safety for a variety of different occupants in a variety of crash conditions.

### BRIEF DESCRIPTION OF THE DRAWINGS

It is an object of the invention to provide a safety configuration for a rearward-facing seat.

FIG. 1 shows a schematic view of an example configuration of the seating in a vehicle with rearward-facing seats;

FIG. 2A shows a side view of a rearward-facing seat with adaptive damping device and an occupant in the seat;

FIG. 2B shows a top view of FIG. 2A;

FIG. 3A shows a second embodiment of a rearward-facing seat with adaptive damping device;

FIG. 3B shows a cross-sectional side view of part of FIG. 3A; and

FIG. 4 shows a third embodiment of a rearward-facing seat with adaptive damping device.

### DETAILED DESCRIPTION

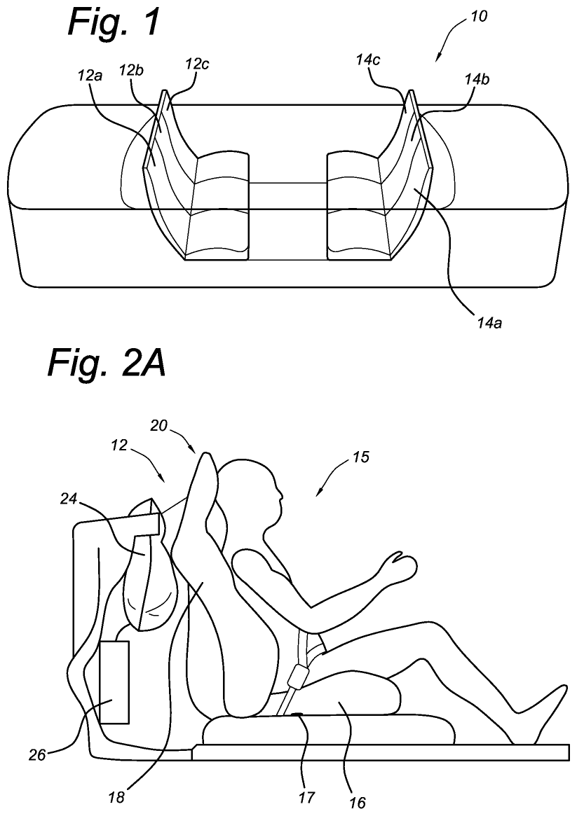

FIG. 1 shows a schematic view of an example configuration of the seating in a vehicle 10 with rearward-facing seats. Such a configuration is sometimes called campfire seating, where the seats are faced toward a center or center line of the vehicle and seat occupants of rearward-facing seats face toward seat occupants of forward facing seats.

Seats 12a, 12b, 12c face rearward and seats 14a, 14b, 14c face in a forward direction in the vehicle. Such a seating configuration is typical for a self-driving or autonomous vehicle as no space is needed for a driver facing forward, as well as space for the typical driving devices (e.g., steering wheel, pedals, etc.).

Most past safety devices and safety configurations have been designed and arranged to protect passengers in forward facing seats. However, such vehicles with rearward-facing seats have different safety considerations than vehicles with only forward facing seating. The forces acting on the passengers in the rearward-facing seats 12a, 12b, 12c are quite different in the event of a collision, and thus new safety configurations are required.

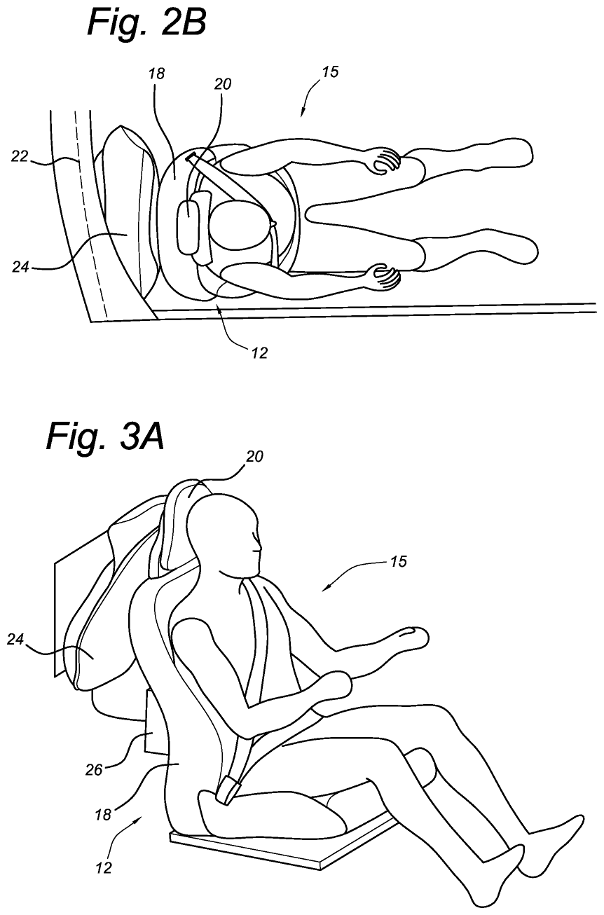

FIG. 2A shows a side view of a rearward-facing seat 12 with an adaptive damping device for protecting an occupant 15 in the rearward-facing seat 12 in the event of a collision, and FIG. 2B shows a top view of FIG. 2A.

Seat 12 includes base 16 with sensor 17, back 28 and headrest 20. Back 18 is connected to base and extends from base 16 to headrest 20. Headrest 20 can be an extension of back 18 or could be a separate part that can, for example, extend up and down with respect to back 18 to align with the head of occupant 15.

Adaptive damping device includes inflatable airbag 24 with adaptable gas generator 26 to supply gas to airbag 24. Airbag 24 can include ventilation holes. Airbag 24 sits behind an upper portion of the back 18 of seat 12 and partially behind headrest 20. In this embodiment, airbag 24 is secured to vehicle 10 body, for example, a cross car beam 22, a beam which typically connects A-pillars in a vehicle and contributes to the lateral and torsional stiffness. In other embodiments the airbag 24 could secure to the cowl and/or upper dash, though could also be other structural parts of the vehicle.

In the event of a collision or other initiation event, gas generator 26 provides gas to airbag 24, inflating airbag to act as a back and possible head cushioning, damping forces acting on occupant 15. Airbag 24 inflates and at least partially fills the space between an upper portion of seat back 18 and the vehicle 10 frame.

Adaptive damping device can adjust the level of inflation of airbag 24 through the volume of gas provided by adaptable gas generator 26 and/or ventilation holes in airbag 24. The adaptation of airbag 24 can be in relation to one or more of crash severity; crash condition, e.g., frontal, rear or side collision; occupant position; and/or occupant size. One or more sensors can send information or signals to adaptive damping device in relation to one or more of these adaptation conditions. For example, vehicle 10 can include one or more sensors that sense a collision is likely or imminent, a sudden acceleration or deceleration of the vehicle; a location of likely impact on the vehicle in a collision; the position of the occupant in the seat; a height of an occupant in the seat; a weight of an occupant, etc. The one or more sensors could be located near or in seat 12 or at other locations in or on the outside of the vehicle, e.g., frontal and rear sensors to sense approaching objects, acceleration or braking sensors to sense sudden acceleration or deceleration.

For example, sensor 17 can determine the weight of occupant 15, and thereby estimate the size of occupant 15. This information can be sent to adaptable gas generator 26 to determine the proper level of inflation of airbag 24 for occupant 15. For example, a larger occupant may require a higher level of cushioning in a crash and therefore generator 26 would provide more inflation for airbag 24 in the event of a collision, whereas a smaller occupant (e.g., a child) may require less inflation provided by gas generator 26 to airbag 24. Such adaptability could further be used to adjust the location and/or rate of inflation as well as levels of inflation in airbag 24.

A crash sensor located on the vehicle could then sense that a collision was imminent. The signal would cause another sensor to determine whether occupant was out of position in seat 12, and could cause the seatbelt to reduce slack and connect occupant to seat. The crash sensor and weight sensor inform the gas generator 26 of a proper inflation rate for airbag 24 according to the weight of occupant 15 and the likely severity of the imminent crash. Gas generator 26 then deploys a mass flow of gas according to this information and provides an appropriate level of inflation of airbag 24 for the occupant 15 and the crash severity.

As mentioned in the background, past systems with rearward-facing seats were related to reversible seating. Due to that, any safety configurations were typically limited and had to be connected to the seat itself for use in forward facing positions or rearward-facing configuration. Additionally, rearward-facing seat configurations result in high forces for occupants in frontal impact collision, forces which are significantly higher than rearward impacts. Past safety solutions for rear impact collisions are not sufficient for frontal impact forces, and are not adaptive to different passengers and/or crash conditions. Thus, there is a need for safety solutions for rearward-facing seat configurations in a frontal impact situation, and particularly for safety solutions which can adapt to the passenger and crash conditions.

The adaptable damping system provides a safety configuration which adjusts to the occupant and/or collision to provide the appropriate safety needed for occupants in rearward-facing seats, even for the high forces of front impact collisions. The placement of airbag 24 at an upper portion of the seat back 18 and in some cases at least partially behind head rest 20 provides protection for occupant 15, and particularly provides protection for the head, neck and brain during a collision. The adaptability allows for the system to provide the proper amount of damping for the situation and occupant, thereby reducing the load on both the occupant and the seat in the event of a collision. The extension of airbag 24 behind headrest 20 can help to stabilize the head rest and therefore the head of the occupant 15. The adaptability additionally allows for the device to adjust for different crash severity and occupant size, thereby providing the appropriate level of damping in various situations.

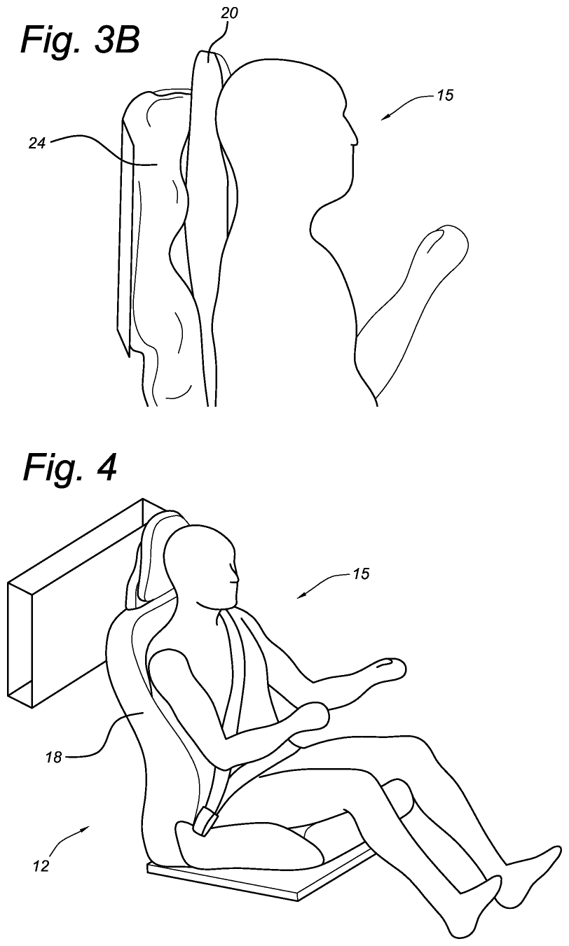

FIG. 3A shows a second embodiment of a rearward-facing seat 12 with an adaptive damping device, and FIG. 3B shows a cross-sectional side view of part of FIG. 3A. Similar parts are labelled similarly to those in FIGS. 2A-2B, and only differences with respect to the embodiment of FIGS. 2A-2B will be discussed.

Adaptive damping device includes airbag 24 with adaptive gas generator 26. Airbag 24 extends behind an upper portion of seat back 18 and behind headrest 20 to or nearly to the top of headrest 20. In this configuration, airbag 24 is connected to or within seat 12 (at least in an undeployed state), as can be seen clearly in FIG. 3B. Gas generator 26 is also connected to seat 12.

Such a configuration of adaptive damping device can allow for protection of occupant 15 in the case of a collision or accident as discussed above. Additionally, the connection of airbag 24 (and possibly gas generator 26) to seat 12 directly can ensure that airbag 24 stays properly positioned for inflation and damping even during a crash with strong forces, and can allow for easier manufacture as airbag 24 can be secured to seat 12 and then installed in vehicle 10.

FIG. 4 shows a third embodiment of a rearward-facing seat 12 with adaptive damping device 30. In this embodiment, adaptive damping device 30 is schematically drawn and represents foam material and/or springs used for damping. The foam material could be, for example, crushable foam that does not rebound. Damping device 30 is positioned behind the upper portion of back 18 and headrest 20 of seat 12, and can be secured to the vehicle and/or seat 12.

Damping device 30 can be used in conjunction with the adaptive damping devices shown in FIGS. 2A-3B. Damping device 30 using foam and/or springs provides a simple, secure and reliable way of dampening forces on occupant 15 in rearward-facing seat 12 in the event of a collision, and will work to protect an occupant 15 even in the event of a catastrophic failure of other systems, for example, the adaptable airbag system.

An adaptive damping device behind an upper portion of the back of a rearward-facing seat can allow for protection of an occupant even from the severe forces which accompany a frontal collision. Specifically, testing found that the risk of head injury, brain injury and neck injury was reduced, in some cases significantly, through the use of an adaptive damping device as compared to a stiff rearward-facing seat. Such an adaptive damping device provides protection for a variety of occupants in a variety of crash situations.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims

What is claimed is:

1. A rearward-facing seat for a vehicle, the rearward-facing seat comprising:
a base;
a back; and
an adaptive damping device behind an upper portion of the back of the seat, wherein the adaptive damping device adapts based on one or more of crash severity or occupant size.

2. The rearward-facing seat of claim 1, wherein the adaptive damping device comprises an inflatable airbag.

3. The rearward-facing seat of claim 2, wherein the inflatable airbag comprises ventilation holes.

4. The rearward-facing seat of claim 1, wherein the adaptive damping device is connected to an upper portion of the back of the seat behind the seat.

5. The rearward-facing seat of claim 1, wherein the adaptive damping device is located within the seat.

6. The rearward-facing seat of claim 1, wherein the adaptive damping device is connected to a vehicle structure.

7. The rearward-facing seat of claim 1, and further comprising a head rest connected to the back.

8. The rearward-facing seat of claim 7, wherein the adaptive damping device extends at least partially behind the head rest.

9. The rearward-facing seat of claim 1, wherein the adaptive damping device further adapts based on one or more of crash conditions or occupant position.

10. The rearward-facing seat of claim 1, wherein the back comprises one or more reinforcing components.

11. The rearward-facing seat of claim 1, wherein the adaptive damping device comprises an adaptive gas generator to regulate the mass flow to the damping device.

12. The rearward-facing seat of claim 1, and further comprising one or more sensors to provide one or more signals to adapt the damping device based on one or more of crash severity, crash conditions, occupant position or occupant size.

13. A vehicle comprising a rearward-facing seat, wherein the rearward-facing seat comprises:
a base;
a back; and
an adaptive damping device behind an upper portion of the back of the seat, wherein the adaptive damping device adapts based on one or more of crash severity or occupant size.

14. A method of safety reinforcement for a rearward-facing seat for a vehicle, the method comprising:
utilizing an adaptive damping device behind an upper portion of a back of the rearward-facing seat, wherein the adaptive damping device adapts based on one or more of crash severity or occupant size.

15. The method of claim 14, further comprising:
employing one or more sensors to provide signals for the adaptive damping device to adapt according to one or more of crash severity, crash conditions, occupant position or occupant size.

16. The method of claim 14, wherein the utilizing an adaptive damping device behind an upper portion of a back of the rearward-facing seat comprises employing an inflatable airbag with an adaptive gas generator such that the inflatable airbag is positioned behind an upper portion of a back of the rear-ward facing seat.

17. The method of claim 16, wherein the inflatable airbag is connected to the rearward-facing seat.

18. An adaptive damping system comprising an adaptive damping device for a rearward-facing seat in a vehicle, the adaptive damping device comprising:
an inflatable airbag connected to the rearward-facing seat or to the vehicle and positioned behind an upper back of the rearward-facing seat; and
an adaptive gas generator connected to the inflatable airbag to provide gas to inflate the inflatable airbag.

19. The adaptive damping system of claim 18, further comprising one or more sensors to provide signals to the adaptive damping system to adapt mass flow to the inflatable airbag according to one or more of crash conditions or occupant position.

20. The adaptive damping system of claim 18, wherein the inflatable airbag is positioned at least partially behind a headrest of the rearward-facing seat.
